(19) United States
(12) Patent Application Publication
(10) Pub. No.: US 2018/0345809 A1
(43) Pub. Date: Dec. 6, 2018

(54) RECHARGING STATION FOR ELECTRIC PUBLIC TRANSPORT VEHICLE, AND FACILITY COMPRISING SUCH A STATION

(71) Applicant: BLUETRAM, Puteaux Cedex (FR)

(72) Inventors: Marc DERRIEN, Concarneau (FR); Michel LE BORGNE, Grand-Champ (FR)

(21) Appl. No.: 15/778,908

(22) PCT Filed: Nov. 10, 2016
(86) PCT No.: PCT/EP2016/077355

§ 371 Date: May 24, 2018

(30) Foreign Application Priority Data
Nov. 30, 2015 (FR) 1561617

(51) Int. Cl. B60L 11/18; H02J 7/00; E04H 1/12

(52) U.S. Cl. CPC B60L 11/1837; H02J 7/0027; B60L 11/184; B60L 2200/18; B60L 11/1844; B60L 11/1827; E04H 1/1211; B60L 11/1816

(57) ABSTRACT

A recharging station for an electric public transport vehicle of the bus or tyred tram type, includes:
at least one first electrical connector intended to electrically connect the station to the vehicle
at least one second electrical connector intended to electrically connect the station to an external electrical energy source; and
a structure defining at least one area for accommodating people;
   the station having the form of a rigid monobloc unit that can be moved and installed on a desired site as a single unit. An electric public transport installation is also provided including such stations.

The present invention relates to an electrical recharging station for an electric public transport vehicle, in particular a land vehicle, such as a bus or a tyred tram. It also relates to an installation comprising such a recharging station.

The field of the invention is the field of recharging stations for electric public transport land vehicles of the bus or tyred tram type equipped with rechargeable electrical energy storage modules in order to supply at least one electric motor of said electric vehicle.

### PRIOR ART

In order to reduce pollution in built-up areas, the use of electric vehicles is undergoing rapid growth, encouraged both by user awareness and also by administrative incentives promoting the purchase and use of electric vehicles. Thus, the number of electric vehicles is continuously increasing in all fields: private use vehicles, rental-type shared use vehicles, public transport vehicles, etc.

Electric public transport vehicles are known that charge electrically at each stop for a very short period, for example 10 seconds. This very short electrical recharging provides sufficient operating range for the vehicle to reach the next stop, during which a new electrical recharging will take place, and so on.

These electric vehicles make it possible to reduce the cost of an electric public transport network, because it is no longer necessary to use catenaries. In addition, the cost, the space requirement and the weight associated with energy storage modules are also reduced.

However, these electric vehicles need to be charged at each stop, which makes it necessary to equip each stop with a recharging station. Current recharging station installation works are long and costly and block the road system. In addition, moving a current recharging station is complex, costly and time-consuming, which constitutes a barrier to changing the public transport network by implementing such recharging stations.

A purpose of the present invention is to overcome these drawbacks.

Another purpose of the invention is to propose a recharging station for an electric public transport vehicle, the installation of which is less complex, less costly and less time-consuming.

Another purpose of the invention is to propose a recharging station for electric public transport vehicles making it possible to increase the flexibility in space of a public transport network, or installation, implementing such stations.

Another purpose of the invention is to propose a recharging station for electric public transport vehicles making it possible to reduce the time and the cost of deploying a public transport network.

### SUMMARY OF THE INVENTION

The invention makes it possible to achieve at least one of these purposes by means of a recharging station for electric public transport vehicle, in particular on-road, and even more particularly of the bus or tyred tram type, comprising:
at least one first electrical connector intended to electrically connect said station to said vehicle,
at least one second electrical connector intended to electrically connect said station to an external electrical energy source, and
a structure defining at least one area for accommodating people;
   said station having the form of a rigid monobloc unit that can be moved and installed on a desired site as a single unit.

Such a station is intended to be installed at each stop of said electric vehicle along a predetermined route in order on the one hand, to define a position where users board the vehicle and alight from the vehicle and, on the other hand, to charge said vehicle.

The station according to the invention thus has the form of a monobloc unit, or a single-piece unit, the movement of which is carried out in the form of a single unit. The recharging station according to the invention can thus be constructed on a manufacturing site remote from the site of use. Once constructed, it can be transported in the form of a single unit to the site of use and installed quickly, cheaply and without the need for significant road work.

As a result, deployment of an electric public transport network implementing recharging stations according to the invention can be carried out more quickly and at lower cost. The recharging station according to the invention even makes it possible to envisage deploying a temporary electric public transport network.

Furthermore, the recharging station according to the invention can be moved at will, without the need for works, or very few works, either on the former site where it was installed or on the new site where it will be installed. As a result, it makes it possible to increase the flexibility in space of a public transport network implementing such stations.

In the present application, “tyred tram” denotes an electric public transport land vehicle mounted on wheels and which is charged at each station, so that it has no need for heavy infrastructures of the rails or catenaries type on the road system. Such an electric vehicle is charged at each station by means of a connector connecting said vehicle to said station.

In addition, by “storage module” is meant an assembly comprising one or more electrical energy storage elements of the supercapacitor or battery type, arranged in a rigid outer shell.

Advantageously, the external electrical energy source can be a source that is not dedicated to said recharging station and present beforehand at the level of the road system. In this case, the recharging station contains components for processing and transformation of the signal delivered by the external source.

According to a non-limitative version, the first electrical connector can be arranged on an arm, called coupler, assembled as a single unit with said station.

Advantageously, the position of the coupler can be adjustable continuously or discontinuously, so as to adapt to the configuration of the site of use.

For example, the position of the coupler can be adjustable in the factory, in particular between several separate positions.

Alternatively, the position of the coupler can be adjustable on the site of use during its installation on the site of use.

Alternatively, or in addition, the position of the coupler can be adjustable on the site of use, during use thereof, with respect to the position of the electric vehicle, in particular during each electrical recharge.

In particular, the position of the coupler can be adjusted for example in a vertical direction.

Optionally, the position of the coupler can alternatively, or in addition, be adjusted in at least one horizontal direction, such as for example a horizontal direction parallel, or perpendicular, to the direction of travel of the vehicle.

According to a particular embodiment, the coupler can be placed in a housing, arranged in a casing, mobile in translation in said housing, between:
a retracted position, in which it is entirely inside said housing, and thus protected, and
a deployed position, in which it leaves the housing and couples with a female connector provided at the level of an electric vehicle.

Such an architecture makes it possible to facilitate the electric coupling between the vehicle and the recharging station, while protecting the coupler when no electrical recharging is taking place.

Alternatively, the first electrical connector can be positioned in a female housing into which is inserted an arm firmly fixed to the electric vehicle.

In a preferred, but non-limitative, version, the station according to the invention can also contain at least one electrical energy storage module, called buffer, intended for storage of the electrical energy supplied by the external electrical energy source, then for supplying said stored electrical energy to the electric vehicle, when said vehicle is electrically connected to said recharging station.

Each buffer electrical energy storage module can comprise one or more supercapacitors.

For example, the buffer electrical energy storage module(s) can be arranged in one or more cabinet(s) provided in the vertical walls of the structure of the recharging station defining the area for accommodating people.

The station according to the invention can advantageously comprise a base, for example made from concrete, ensuring the stability of said station.

Such a base can have the form of a slab, for example made from concrete, assembled as a single unit with said station on the lower part of said station, for example on vertical walls of said station.

Optionally, the station can comprise means for fixing said station to the ground, for example by screwing, in particularly by means of the base.

The station according to the invention can advantageously comprise attachment means, arranged in order to cooperate with lifting means, such as chains or similar, so as to lift and transport it as a single unit.

These attachment means can comprise lifting rings.

Preferentially, the attachment means can be rigidly fixed to the base.

Preferentially, the attachment means, and more particularly the lifting rings, can be removable from the base, such that they are removed once the station is installed.

In addition, the accommodation area can contain one or more seats/benches assembled as a single unit with said station.

This or these seats or benches can be fixed on a vertical wall of said station, for example by screwing.

The recharging station according to the invention can also comprise a roof, in particular assembled as a single unit with said station.

The roof can alternatively be removable, in order to facilitate the transportation of the recharging station.

Such a roof is preferably arranged above at least a part of the accommodation area of said station.

Advantageously, the station according to the invention can comprise at least one display screen integrated in, or fixed to, a wall of said station.

According to a preferred embodiment example, the station according to the invention can have the shape of an “L”, the vertical branch of the “L” being formed by a vertical wall parallel to the direction of travel of the vehicle and the horizontal branch of the “L” being formed by a wall containing the first electrical connector.

Each vertical wall can contain one or more compartments, defined in the thickness of said wall and comprising:
at least one buffer electrical energy storage module, or
a device for managing the recharging station such as, for example, a module for monitoring and controlling the electrical recharging, or a module for managing the different components of the recharging station.

The station according to the invention can advantageously contain means for adjusting its position with respect to the surface on which it is placed, or with respect to a traffic lane of the electric vehicle.

The adjustment means can for example contain adjustment screws.

At least one means for adjusting the position can be fixed to a vertical wall of the recharging station according to the invention.

Alternatively, or in addition, at least one adjustment means can be fixed to a base of the recharging station according to the invention, if said station contains such a base.

According to another aspect of the invention, an electric public transport installation is proposed, such as, for example, an electric public transport network on-road or on rails, comprising at least one recharging station according to the invention.

Preferentially, the installation according to the invention can comprise a plurality of recharging stations according to the invention, distributed along a predetermined route or public transport service.

At least one recharging station of the installation according to the invention can be connected to an overhead electrical energy network, for example by means of a cable connecting the second electrical connector of said station to said overhead electrical energy network.

Alternatively, or in addition, at least one recharging station of the installation according to the invention can be connected to an underground electrical energy network.

In this case, for at least one recharging station connected to an underground electrical energy network, the installation according to the invention may comprise at least one mast, offset with respect to said station, said mast being electrically connected:
on the one hand, to said underground electrical energy network, and
on the other hand, to said station, and in particular to the second electrical connector, by an overhead electrical cable;
   so that said mast forms an electrical gateway between said underground electrical energy network and said recharging station.

The installation according to the invention can be an electrical public transport network, on-road or on rails, temporary or long-term.

### DESCRIPTION OF THE FIGURES AND EMBODIMENTS

Other advantages and characteristics will become apparent on examination of the detailed description of an embodiment which is in no way limitative, and the attached drawings, in which:

FIGS. 1a-1d are diagrammatic representations from different viewing angles of a non-limitative example of a recharging station according to the invention;

FIGS. 2a-2d are diagrammatic representations from different positions of a coupler of a recharging station according to the invention;

FIG. 3 is a diagrammatic representation of an installation according to the invention;

FIGS. 4 and 5 are diagrammatic representations of two configurations for connecting a recharging station according to the invention to an electricity distribution network;

FIG. 6a is a diagrammatic representation according to an exploded view of a recharging station, without the exterior trim elements;

FIG. 6b is a diagrammatic representation of the recharging station in FIG. 6a, assembled and viewed from the front; and

FIG. 6c is a diagrammatic representation of the recharging station in FIG. 6a, assembled and viewed from the side.

It is well understood that the embodiments which will be described below are in no way limitative. It is possible in particular to imagine variants of the invention comprising only a selection of features described hereinafter, in isolation from the other features described, if this selection of features is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In the figures, elements common to several figures retain the same reference.

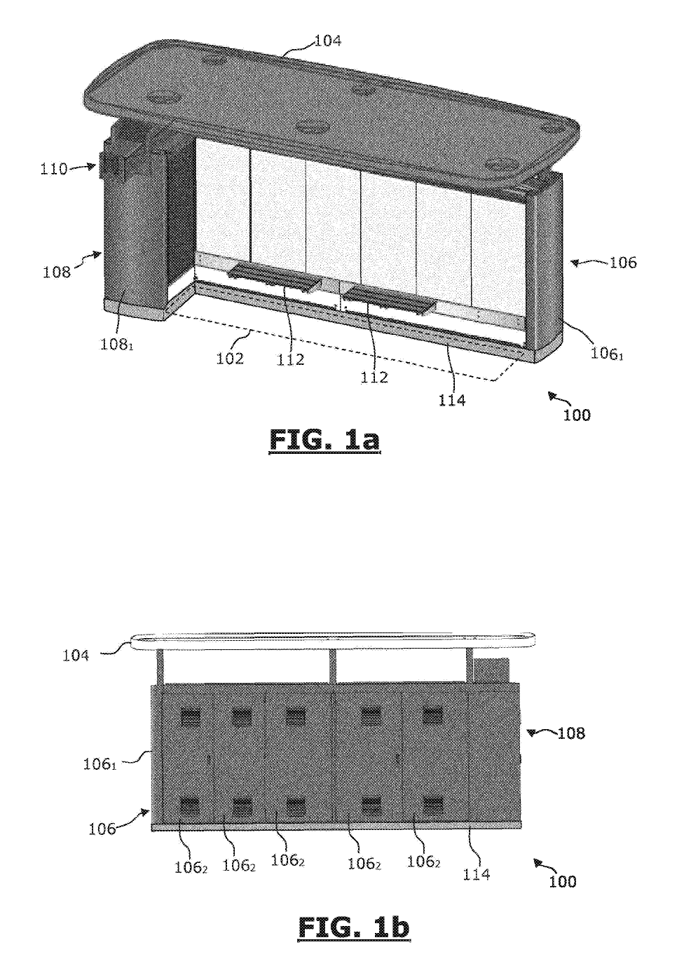

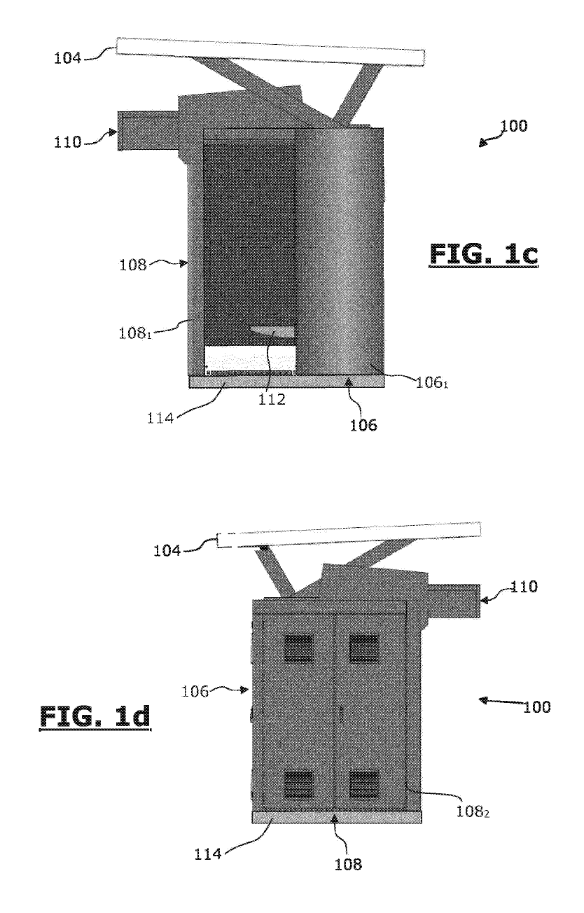

FIGS. 1a-1d are a diagrammatic representation of a non-limitative example of a recharging station according to the invention.

FIG. 1a is a diagrammatic representation of the recharging station 100 according to an isometric view from the front. FIG. 1b is a diagrammatic representation of the recharging station 100 according to a view from behind. FIGS. 1c and 1d are diagrammatic representations of the recharging station 100 according to views from the side.

The recharging station 100 shown in FIGS. 1a-1d has the form of a rigid monobloc unit which can be moved as a single unit, for example from a manufacturing site to a site of use, or from a first site of use to a second site of use.

The recharging station 100 contains a first electrical connector (not shown) intended to electrically connect the station 100 to an electric vehicle in order to charge the vehicle for a very short time, for example of the order of 10 to 20 seconds.

The recharging station 100 receives electrical energy from an electrical energy network, underground or overhead, by utilizing at least one second electrical connector (not shown).

The station 100 contains a structure defining an area 102 for accommodating people wishing to board an electric vehicle when the latter stops at said station 100 and is charged by said station 100.

The recharging station 100 contains, above the accommodation area 102, a roof 104, assembled rigidly and as a single unit with the station 100.

The recharging station 100 contains a vertical wall 106, called longitudinal, arranged parallel to a direction of travel of the vehicle, and a vertical wall 108, called transverse, arranged perpendicular to said direction of travel.

The first electrical connector of the recharging station is arranged on an arm (not shown in FIGS. 1a-1d), called coupler, which is arranged in a casing 110 placed above the transverse wall 108.

The accommodation area is equipped with two benches 112 firmly fixed to the longitudinal wall 106.

In the lower part, the recharging station contains a base 114, made from concrete, in order to ensure the stability of the station 100 which may not be attached to the ground. The base 114 is rigidly fixed to the walls 106 and 108.

The vertical walls 106 and 108 are connected to each other so as to form an “L”.

The free end of each vertical wall 106 and 108 contains a pillar, respectively 106₁ and 108₁.

Each vertical wall 106 and 108 comprises a double thickness, in which are arranged electrical components or buffer electrical energy storage modules. For example, the longitudinal wall 106 contains five cabinets 106₂ (see FIG. 1b), arranged in the thickness of the wall 106 and comprising, in particular, buffer electrical energy storage modules. Each buffer electrical energy storage module contains several supercapacitors. In addition, the longitudinal wall 108 contains a cabinet 108₂ (see FIG. 1d), arranged in the thickness of the wall 108 and comprising the modules for managing the electrical components of the recharging station 100, in particular for ensuring the operation of the recharging station 100.

In particular, the recharging station 100 contains transformers (not shown) for adapting the electrical charging signal supplied to the vehicle from a signal supplied by the existing, non-dedicated, electricity distribution network.

Each cabinet 106₂ and 108₂ is independently and individually accessible by utilizing a lockable rotary door.

Of course, this arrangement is non-limitative. For example, the positions of the buffer electrical energy storage modules and the electrical components can be inverted.

Each wall 106 and 108 is made by utilizing a rigid frame defining a double wall by utilizing longitudinal members, vertical members and horizontal members rigidly fixed to each other by bolting or by welding. The roof 104 is connected to the longitudinal wall 106 by utilizing rigid profiles bolted to said frame.

In the examples shown in FIGS. 1a-1d, the recharging station 100 has the following dimensions:
length: 6 metres,
width: 3 metres, and
height: 3.2 metres.

The roof 104 of the station 100 can be made from polyester. The station can contain glass, stainless steel or sheet metal trim elements.

Moreover, as shown in Figure la, the base 114 is designed so as to also form an L, like the arrangement between the walls 106 and 108. In an embodiment variant (not shown), the base 114 can have a substantially parallelepipedal shape, so as to form a base in this way delimiting the area 102 for accommodating people. Such a base thus extends on either side of the walls 106 and 108 in order to form a wider and more solid base. Such a base thus makes it possible to have increased stability on the ground and, where necessary, to facilitate the transportation thereof.

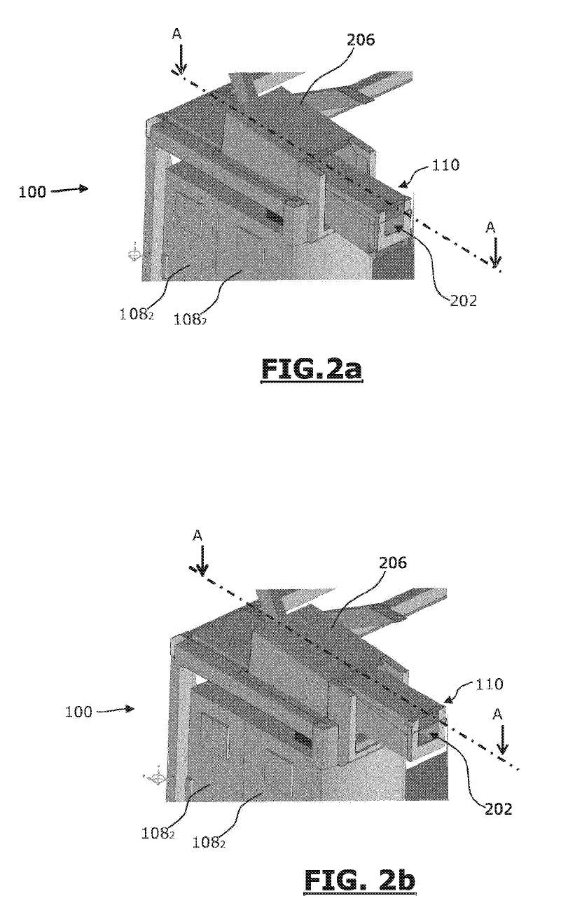

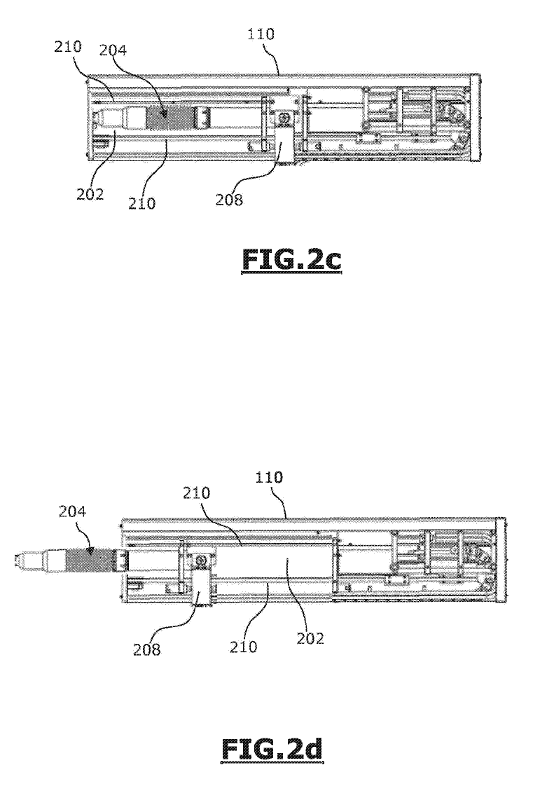

FIGS. 2a-2d are diagrammatic representations from different positions of a coupler of a recharging station according to the invention.

In particular, FIGS. 2a and 2b give a diagrammatic representation according to an isometric view of the casing 110 firmly fixed to the recharging station. FIGS. 2c and 2d give a diagrammatic representation in cross-section of the casing 110 following the line AA shown in FIGS. 2a and 2b.

The casing 110 contains a housing 202 intended to accommodate and guide the coupler 204 (see FIGS. 2c and 2d) bearing the first electrical connector to a female electrical connector provided on the side of the electric vehicle.

The position of the coupler 204 can be adjusted by means of the casing 110. In fact, the casing 110 is positioned in a cover 206 (see FIGS. 2a and 2b) fixed above the transverse wall 108. The position of the casing 110 in the cover 206 is adjustable, at least in the vertical direction. This adjustment can be made by utilizing horizontal members, on which the casing 110 is fixed and for which several positions are provided in the cover 206 in the vertical direction.

FIG. 2a is a diagrammatic representation of the casing 110, and therefore of the coupler, in a low position and FIG. 2b is a diagrammatic representation of the casing 110, and therefore of the coupler, in a high position.

Moreover, the coupler 204, shown in FIGS. 2c and 2d is free in translation in the housing 202 between:
a retracted position, in which it is entirely inside said housing 202, and thus protected, and
a deployed position, in which it leaves the housing 202 and is coupled with a female connector provided at the level of the electric vehicle.

The translational movement of the coupler 204 between the retracted position and the deployed position can be ensured by a motor 208 which moves on rails 210 provided in the housing 202.

FIG. 2c is a diagrammatic representation of the coupler 204 in the retracted position and FIG. 2d is a diagrammatic representation of the coupler 204 in a deployed position.

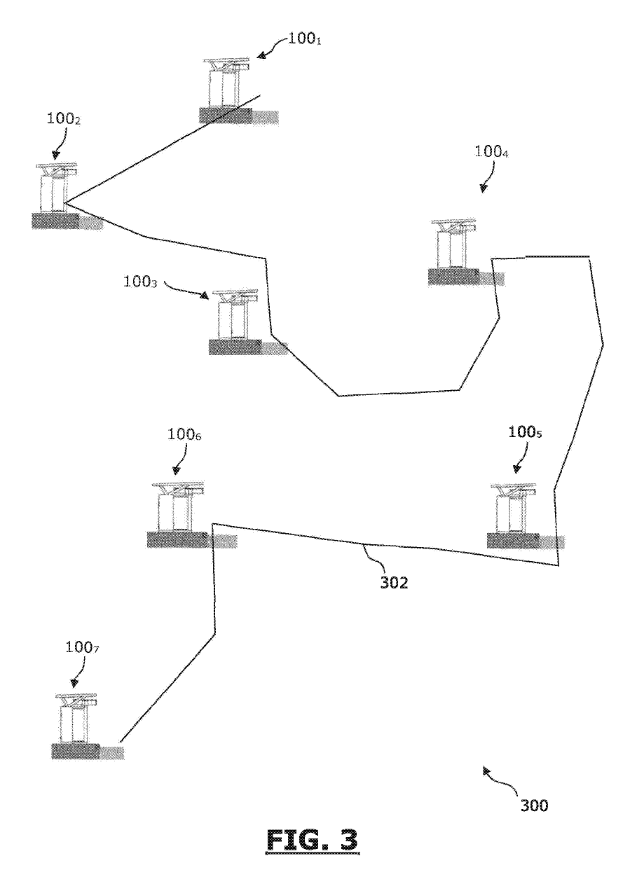

FIG. 3 is a diagrammatic representation of an installation according to the invention.

The installation 300 contains seven recharging stations 100₁-100₇ along a predefined route 302 along which one or more electric vehicles travel. Each recharging station 100₁-100₇ can be identical to the recharging station 100 in FIGS. 1a-1d.

Each electric vehicle is charged at each recharging station 100₁-100₇.

The installation 300 can be a public transport route that is fixed and long-term. Alternatively, the installation 300 can be a temporary public transport route, set up temporarily for a given time period, and changed or removed at the end of said given time period.

Of course, each electric vehicle can be designed to have a sufficient operating range to reach not only the next station but also the one after that, in the event that recharging at the next station is not possible for various reasons.

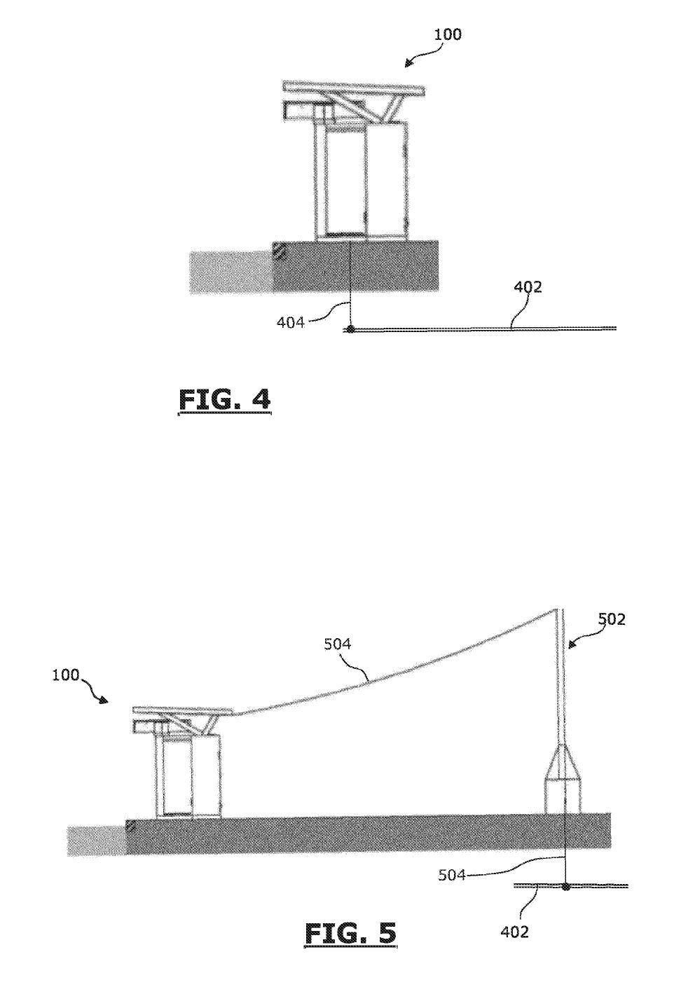

FIG. 4 is a diagrammatic representation of a first configuration for connecting a recharging station to an electricity distribution network.

In the configuration shown in FIG. 4, the station 100 is connected to an underground distribution network 402 by a connection 404 descending to the network 402 directly at the recharging station 100, and in particular under the recharging station 100.

According to the invention, the distribution network 402 is an existing network on the road system which is not dedicated to the recharging station 100.

FIG. 5 is a diagrammatic representation of a second configuration for connecting a recharging station to an electricity distribution network.

In the configuration shown in FIG. 5, the station 100 is connected to an underground distribution network 402 by means of a mast 502. The station 100 is connected to the mast 502 by an overhead cable 504.

The mast 502 is connected to the underground network 402 by a vertical cable 504 descending to said underground network 402 at the mast 502.

In this configuration, the mast 502 makes an electrical connection gateway between the station 100 and the network 402.

Of course, according to an alternative not shown in the figures, the station can be connected to an overhead electricity distribution network.

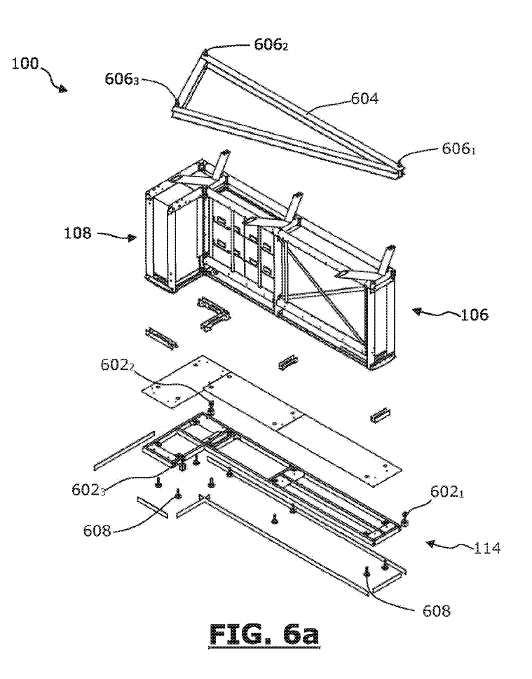

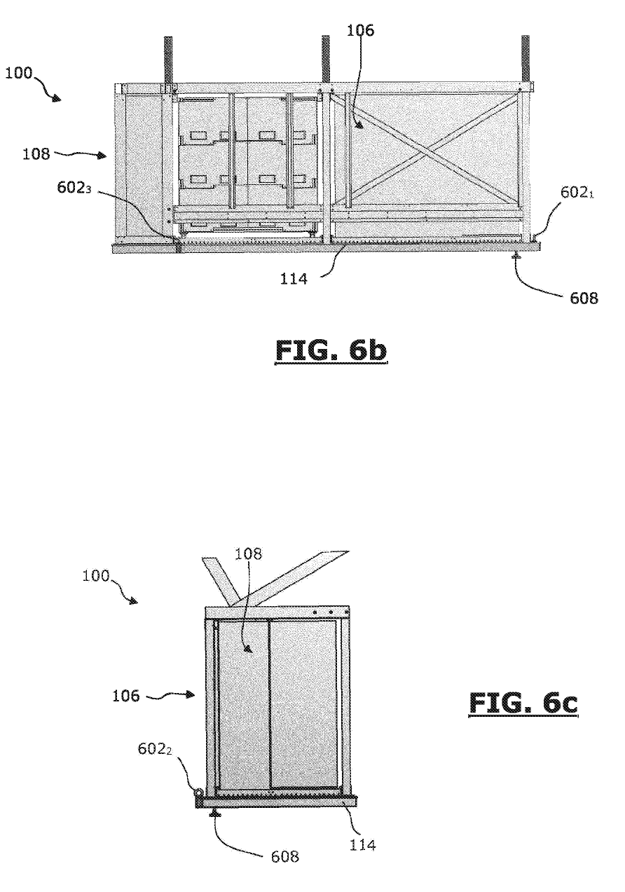

FIG. 6a is a diagrammatic representation of a recharging station according to an exploded view, and without the trim elements and the roof. FIG. 6b is a diagrammatic representation of the recharging station in FIG. 6a, assembled and viewed from the front. FIG. 6c is a diagrammatic representation of the recharging station in FIG. 6a, assembled and viewed from the side of the wall 108.

As can be seen in FIG. 6a, each wall 106 and 108 is made by utilizing a rigid frame defining a double wall by utilizing longitudinal members, vertical members and horizontal members rigidly fixed to each other by bolting or by welding.

The station 100 contains three lifting rings 602₁-602₃, rigidly fixed to the base 114 and used for transporting the station 100. Lifting means, such as chains or the like, are passed though the rings 602₁-602₃ in order to lift and transport the station, for example using a crane.

The lifting rings 602₁-602₃ can advantageously be fixed to the base 114 in a detachable or removable manner, so that they can be removed from the base 114 once the recharging station 100 has been transported and installed on site.

Moreover, during transport of the recharging station 100, a transport frame 604 can be used above the recharging station 100 in order to protect the station while it is lifted and transported, but above all to balance the loads during these operations. To this end, the frame 604 can comprise rings 606₁-606₃, placed opposite the lifting rings, respectively 602₁-602₃, and intended to receive and guide the chains passed through each of the lifting rings 602₁-602₃, so that these chains remain parallel to each other and substantially vertical during lifting of the station 100 and do not rest against the elements, more particularly the walls 106, 108 of the recharging station 100 and thereby damage it when it is lifted and transported.

Moreover, the base 114 of the station 100 can contain adjustment means 608, arranged according to the configuration of the station 100 and distributed in a predefined manner, so as to make it possible to adjust the relative position, more particularly the height and/or the inclination of the entire monobloc station 100 with respect to the ground, as a function of the constraints encountered on the road system, more particularly at the level of the movement of the electric vehicle intended to arrive opposite the station 100.

By way of example, the adjustment means contain screws 608, partially embedded into the thickness of the base and projecting downwards, so as to allow the height of the walls 106 and 108 to be adjusted by screwing with respect to the base 114, and therefore with respect to the ground or the traffic lane of the associated vehicle. This therefore makes it possible to optimize the positioning of the station with respect to the ground and to ensure an optimal connection between the connection elements of the vehicle and of the station.

Of course, the invention is not limited to the examples detailed above. The recharging station can also comprise one or more display panels, one or more display screens etc. The means for actuating the coupler, the means for adjusting the coupler and the station can be different etc.

1. A recharging station for electric public transport vehicle of the bus or tyred tram type, comprising:
at least one first electrical connector intended to electrically connect said station to said vehicle
at least one second electrical connector intended to electrically connect said station to an external electrical energy source; and
a structure defining at least one area for accommodating people;
said station having the form of a rigid monobloc unit that can be moved and installed on a desired site as a single unit.

2. The station according to claim 1, characterized in that the first electrical connector is arranged on an arm, called coupler, assembled as a single unit with said station.

3. The station according to claim 2, characterized in that the position of the coupler is adjustable continuously or discontinuously.

4. The station according to claim 2, characterized in that the coupler is placed in a housing, arranged in a casing that is mobile in translation in said housing, between:
a retracted position, in which it is entirely inside said housing, and thus protected; and
a deployed position, in which it leaves the housing and is coupled with a female connector provided at the level of an electric vehicle.

5. The station according to claim 1, characterized in that it also contains at least one electrical energy storage module, called buffer, intended for the storage of electrical energy supplied by the external electrical energy source, then for supplying said stored electrical energy to the electric vehicle, when said vehicle is electrically connected to said recharging station.

6. The station according to claim 1, characterized in that it comprises a base, for example made from concrete, ensuring the stability of said station.

7. The station according to claim 1, characterized in that it comprises attachment means arranged in order to cooperate with lifting means, in order to lift it and transport it as a single unit.

8. The station according to claim 6, characterized in that the attachment means are rigidly fixed to the base.

9. The station according to claim 6, characterized in that the attachment means are removable.

10. The station according to claim 1, characterized in that the accommodation area contains one or more seats or benches assembled as a single unit with said station.

11. The station according to claim 1, characterized in that it also contains a roof, in particular assembled as a single unit with said station.

12. The station according to claim 1, characterized in that it also contains at least one display screen integrated into, or fixed to, a wall of said station.

13. The station according to claim 1, characterized in that it has the shape of an “L”, the vertical branch of the “L” being formed by a vertical wall parallel to the direction of travel of the vehicle and the horizontal branch of the “L” being formed by a vertical wall containing the first electrical connector.

14. The station according to claim 1, characterized in that it contains adjustment means of its relative position with respect to the surface on which it is placed, or with respect to a traffic lane of the electric vehicle, in particular of the adjustment screw type.

15. An electric public transport installation comprising at least one recharging station according to claim 1.

16. The installation according to claim 15, characterized in that at least one recharging station is connected to an overhead electrical energy network.

17. The installation according to claim 15, characterized in that at least one recharging station is connected to an underground electrical energy network.

18. The installation according to claim 15, characterized in that it comprises, for at least one recharging station connected to an underground electrical energy network, at least one mast, offset with respect to said station, said mast being electrically connected:
on the one hand, to said underground network, and
on the other hand, to said station by an overhead electrical cable;
so that said mast forms an electrical gateway between said underground electrical energy network and said recharging station.
